(19) United States
(12) Patent Application Publication
(10) Pub. No.: US 2005/0039135 A1
(43) Pub. Date: Feb. 17, 2005

(54) Systems and methods for navigating content in an interactive ticker

(76) Inventors: Konstantin Othmer, Mountain View, CA (US); Carl J. Stocklein, Madison, WI (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/929,000

(22) Filed: Aug. 26, 2004

Related U.S. Application Data
(63) Continuation-in-part of application No. 10/917,200, filed on Aug. 11, 2004.
(63) Continuation-in-part of application No. 10/916,960, filed on Aug. 11, 2004.
(60) Provisional application No. 60/494,644, filed on Aug. 11, 2003.

(51) Int. Cl. G09G 5/00

(52) U.S. Cl. 715/774; 715/831; 715/854

(57) ABSTRACT

Tickers on communications devices are navigated using a navigation mechanism associated with the communications devices. The navigation mechanisms can permit a user to navigate through content in a ticker or to configure presentation attributes of the ticker. Alternately, the navigation mechanisms can allow the user to initiate secondary actions associated with ticker content, such as launching uniform resource identifiers, launching local applications, accessing remote data or applications, or performing other interactive actions. When the secondary action requires a network connection, the mobile communication device can immediately transmit a request through the network if a network connection is present or can wait until a network connection becomes available. The navigation mechanism can be a keypad of a mobile communication device, soft keys, voice command receivers, motions sensors that respond to motion of the mobile communications device, or other input devices.

### RELATED APPLICATIONS

This application is a continuation-in-part of U.S. patent application Ser. No. 10/917,200, filed Aug. 11, 2004, entitled “Bandwidth Usage Optimization and Enhanced Performance for Wireless Networks,” and is a continuation-in-part of U.S. patent application Ser. No. 10/916,960, filed Aug. 11, 2004, entitled “Systems and Methods for Populating a Ticker with Location-Based Content”, both of which claim the benefit of U.S. Provisional Patent Application Ser. No. 60/494,644, filed Aug. 11, 2003. The foregoing patent applications are incorporated herein by reference.

### BACKGROUND OF THE INVENTION

1. Field of the Invention

The present invention relates generally to communications systems, methods and devices. More particularly, exemplary embodiments of the invention concern systems and methods directed to navigating and interacting with content displayed in an interactive ticker on a mobile communication device.

2. Related Technology

The popularity of the Internet has given rise to a plethora of information services as consumers have become accustomed to accessing timely, personalized news and information. As a result, demand for these types of content services continues to grow. Scrolling information displays, referred to herein as “tickers,” are one type of content distribution mechanism that can give a viewer a quick, high-level update, and they have become commonplace on the television news and on sports channels, providing viewers with “at-a-glance” headlines, breaking news, weather reports, sports scores and other updates.

One early example of a scrolling information display or “ticker” on a personal computer (PC) system was that provided by Pointcast. Through the Pointcast service, PC users could subscribe to news and information channels of interest and receive periodic updates on their computer displays, often in the form of a scrolling information display at the bottom of the user's display screen—commonly known as a ticker. An even earlier example of the use of tickers in conjunction with a PC was the ticker provided by gaming company Catapult Entertainment, Inc. The Catapult ticker, in addition to providing information to users of the gaming system about news and current events and gaming-related information such as upcoming tournaments, high scores, and new software releases, was also interactive through the use of the computer mouse. Rather than being limited to the information in the ticker, the user could click on an item in the ticker having a Universal Resource Identifier (URI) associated with it, which would then cause a web page to be displayed with additional information about that item. More recently, through the use of messaging systems with near-universal reach such as the Short Messaging System (SMS), mobile workers can now receive up-to-the-minute business, financial and customer information on their wireless devices from various news and entertainment content providers and from many other information sources, including corporate portals and customer relationship management applications. Furthermore, tickers are beginning to appear as a method for dynamic information display on wireless communication devices, such as cellular telephones, personal digital assistants (PDAs), and “smart” phones.

While the value of receiving personalized, timely information in a condensed, quickly-read format such as a ticker is indisputable, the information tickers known in the art could be significantly improved. The continued, rapid growth of wireless communication device use is a reflection of the mobile society in which we live, and increasingly we rely on these devices for news and other information in addition to staying in touch with co-workers, friends and family. Smaller devices such as wristwatches that can receive information updates promise to make it even more convenient to always carry a wireless communication device, and as applications for these devices such as messaging, calendars and appointment reminders, news alerts, and traffic reports become more popular, the wireless communication device is becoming a more essential requirement for users to guide them through the day. Although broadcasting content to a mobile device and displaying it within a ticker format is known in the art, the mobile device user is unable to interact with the content in the ticker and can only passively view the content presented, nor is the device user able to view, navigate and interact with the content while disconnected from the network, which significantly decreases the value of the content to the user and to the content provider.

### BRIEF SUMMARY OF AN EXEMPLARY EMBODIMENT OF THE INVENTION

In general, exemplary embodiments of the invention concern systems and methods for navigating and interacting with content displayed in an interactive ticker on the display device or screen of a communication device such as a cellular telephone, and a personal digital assistant (PDA), a display device associated with a set top box, and any other communication device having a display device or an associated display device and enabled to wirelessly receive data. As used herein, the term “ticker” refers to a portion of a display screen on a communication device in which information is dynamically displayed. The ticker should not be construed to be limited to a scrolling information display at the bottom of the screen, rather, the ticker can take many shapes and forms, and the location of the ticker on the screen as well as many other ticker characteristics can be customized to suit the needs and preferences of the user.

More specifically, embodiments of the invention provide for receiving content on a communication device. The content is presented to the user in an interactive ticker on the display of the communication device. Using keys on a keypad of the communication device or on a remote control device associated with the communication device, device soft keys, other device buttons and wheels, voice commands, or by moving the device in a particular way, such as shaking it, turning it from side to side or upside down, or otherwise moving the device (for convenience, these navigation mechanisms are hereinafter referred to collectively as “ticker navigation mechanism(s)”), the device user is able to interact with the content displayed within the ticker whether or not the device has an active network connection. Content received into the ticker of the communication device can include many different types of media, such as text, audio, and video that is transmitted to the device over a network, as well as content received into the ticker from local applications resident on the device. The content displayed within the interactive ticker may also be referred to herein as “ticker item(s)”.

Using one or more of the aforementioned ticker navigation mechanisms, the user can perform a variety of actions on the ticker items, including changing the speed with which the ticker scrolls, highlighting and/or selecting ticker items, scrolling forward, scrolling backward, pausing the ticker, scrolling to the next or previous item, scrolling to the next or previous category of information, deleting ticker items and otherwise navigating and interacting with the content displayed in the ticker. In some cases, navigating to a ticker item and selecting it using a ticker navigation mechanism causes a secondary action to be performed, such as presenting supplemental information that expands on the subject of the ticker item, launching an application resident on the communication device, causing additional content, applications, or services to be downloaded to the communication device or accessed by the communication device, or causing any of a number of other actions to be performed.

The ticker itself may take many forms and shapes, and its location on the display screen as well as many other characteristics of the ticker and the ticker items are customizable by the user. In one example, the user may have configured the ticker to scroll across the bottom of the display on the communication device. In another, the ticker may appear at the top of the display screen. The appearance of the ticker, such as its shape, the background color, the degree of transparency and fonts used, as well as notification mechanisms and many other attributes may be further customized by the user.

In the exemplary embodiment, a user has a mobile communication device that is suitably equipped to receive data using for example, a cellular network, the short message service (SMS), the 802.11 family of wireless local area networks (WLAN), a Bluetooth network, satellite and terrestrial broadcast networks or any other type of network, combination of networks, or network connections to which the mobile communication device can connect and receive data transmissions. These data transmission modes are also referred to herein as “bearers”. While the methods of the invention are particularly well-suited to mobile devices, they should not be construed to be limited to mobile devices. The ticker navigation mechanisms of the invention may also be used in conjunction with a set top box, for example.

Returning to the exemplary embodiment, the mobile device is also equipped with ticker client software that enables an interactive ticker to be rendered on the display of the mobile device. The ticker client software may further communicate with a ticker server to receive content that has been aggregated from multiple content providers and is then provided to the interactive ticker on the mobile device based on certain considerations. The user may have a relationship with one or more content providers from which content is received into the interactive ticker of the mobile device, and the content may also be transmitted to the user's mobile device without the user having subscribed to any particular service or formed a relationship with a content provider. In some cases the user may express preferences for certain types of content that may then be received by the ticker client software and displayed in the interactive ticker. In other cases the user may choose to block certain types of content.

Based on any of a number of conditions, user preferences, and content display rules, or any combination of these, the interactive ticker on the mobile device periodically receives content. Moreover, based on considerations such as the capabilities of the mobile device, the traffic load on a wireless network, and the size, type and priority of the data transmission intended for the ticker of the mobile device, one bearer may be selected instead of another to utilize the available network resources optimally and transmit content to the ticker of the mobile device in a way that is cost efficient and may also conserve bandwidth. Furthermore, any of a number of content delivery mechanisms that operate in conjunction with a bearer may be used to deliver content to the ticker, including multimedia messaging service (MMS), really simple syndication (RSS), email, and many other content delivery mechanisms.

Rules governing the display of content in the interactive ticker may be received in metadata associated with the transmitted content and stored on the mobile device. A scheduling system of the ticker client software then considers the display rules, user preferences, current conditions such as the user's location and other considerations to determine when and how the received content should be displayed in the interactive ticker. Once the content is displayed in the interactive ticker on the mobile device, the user can use any of the aforementioned navigation mechanisms to navigate and interact with the content.

For example, the mobile device user may have expressed a preference for content having to do with professional baseball, and in particular the San Francisco Giants baseball team is the user's favorite team. As a result, baseball scores from all of the professional teams are transmitted to the user's mobile device as they become available and they are received by the interactive ticker client software on the mobile device. The baseball scores are saved to a data store of the interactive ticker client software, and the scheduling system then determines the timing, order and frequency with which the baseball scores should be displayed in the interactive ticker, relative to the other content received and scheduled for display.

In this case, while the user is interested in all of the latest baseball scores, she is particularly eager to know the result of an important San Francisco Giants game. From time to time, baseball scores are displayed in on her mobile device and the scores appear among all of the other content displayed in the ticker. At any time, the user can navigate through the ticker items using one or more of the ticker navigation mechanisms. For example, the user may have configured the interactive ticker to appear at the top of the display screen and to scroll ticker items from right to left as they appear in the ticker. Pressing and holding the right arrow key on the keypad of the mobile device, for example, allows the user to search for the score of the Giants' game by causing the ticker to scroll forward to the next item in the ticker at a faster rate than the default scroll speed, pause on the ticker item, scroll at a faster rate to the next ticker item, pause, and so on. Releasing the right arrow key slows the scroll speed of the ticker to the default speed, allowing the user to focus on the Giants' score. At the point at which the ticker item is paused, or at any other time, the user may use a soft key on the mobile device, such as “select” to highlight the score. Using the select soft key a second time causes the item to be selected. Upon selecting the Giants' score ticker item in the interactive ticker, the user may be presented with supplemental information such as a web page that contains a synopsis of play highlights and statistics from the game. Returning to the ticker, the user might see an icon for a video clip which can be selected from the interactive ticker. Selection of the video icon may present the user with a video clip of a post-game interview with her favorite Giants player. Once she has finished watching the video, she may use the arrow key once again to scroll to the video icon, pause on the icon, and then press the “3” or “D” key on the keypad to delete the video clip from the interactive ticker.

Content from any of a number of content sources can be transmitted to the mobile device in such a way as to avoid interfering with the other communication services of the device and without the user having taken any action. For example, a content update can be sent to the ticker on the mobile device when it is idle. After content is transmitted to the device, the user may navigate and interact with the content whether or not the device maintains a connection to the network. While disconnected from the network or “offline”, the user has the ability to perform all of the ticker navigation mechanisms disclosed herein. Commands issued by the user while offline to cause a secondary action such as retrieving supplemental information or downloading software, for example, can be stored by the ticker client software and then executed once a network connection is resumed, without requiring the user to take additional action. The user can also view, navigate, and interact with the ticker items while engaging in a telephone call or other communication session by using one of the aforementioned ticker navigation mechanisms to navigate the interactive ticker.

As previously noted, the methods of the invention may also be implemented in conjunction with a set top box. In this case, a remote control device enabled with ticker navigation mechanisms and associated with the set top box may be used to interact with ticker client software installed on the set top box which enables an interactive ticker to be displayed on a display device associated with the set top box. The ticker navigation mechanisms of the remote control device then allow an interactive ticker displayed on a display device associated with a set top box to be navigated as previously described.

These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view illustrating aspects of an exemplary operating environment for embodiments of the invention.

FIG. 2 is a schematic view illustrating aspects of ticker client software.

FIG. 3 is a schematic view illustrating examples of ticker navigation mechanisms on a mobile communication device

FIG. 4 is a schematic view of an exemplary implementation of a ticker server.

FIG. 5 is a flow chart illustrating aspects of a process for navigating ticker items and causing a secondary action to be invoked.

### DETAILED DESCRIPTION OF EMBODIMENTS OF THE INVENTION

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In general, embodiments of the invention are concerned with navigating and interacting with content that is transmitted to a mobile communication device and displayed within an interactive ticker on the device. Communication devices that may be employed in conjunction with the invention include set top boxes, cellular telephones, PDAs, “smart phones” and any other device having an associated display device and suitably equipped to establish communication with a network.

Embodiments of the invention include ticker client software that is installed on the communication device to enable it to render an interactive ticker on the display screen or other display device of the communication device, to receive content and display it within the interactive ticker, and to enable ticker navigation mechanisms, such as keys on the keypad of a device, device soft keys, other device buttons and wheels, voice commands, or device motion to be used to navigate and interact with the ticker and ticker items. In general, the navigation mechanisms can be any suitable mechanism, such as those enumerated above, and exclude a computer mouse. In particular, the communication devices receive input with a navigation mechanism other than a computer mouse that provides a convenient way of enabling a user to interface with the communication device. As can be appreciated, the nature of the preferred navigation mechanism depends on the type of communication device that is being used. For instance, keypads, voice commands, device motion, soft keys, and the like are particularly well suited for use as navigation mechanisms for mobile communication devices. Remote control devices, voice commands, etc., are examples of navigation devices that are particularly useful for set top boxes.

Content may be provided to the interactive ticker on the device from multiple content sources and using any of a number of bearers with which the device is equipped to communicate. Furthermore, multiple content delivery mechanisms, such as MMS, RSS, email, and many other content delivery mechanisms that operate in conjunction with a bearer are supported by the ticker. Ticker client software may communicate with a ticker server to receive content, exchange other types of data and execute navigation commands. MMS messages, email messages and other content may be sent to the ticker from external sources or the device user might send them to his own ticker as a form of “reminder” or “to do” list, for example.

Furthermore, the manner in which the transmitted data is displayed can include a wide variety of content presentation attributes, including the shape, size, speed and location on the display screen of the interactive ticker, multiple font effects, and audible or tactile notifications indicating that new content has arrived at the ticker, all of which are customizable by the device user utilizing the ticker navigation mechanisms of the invention.

I. Operating Environments and Associated Devices

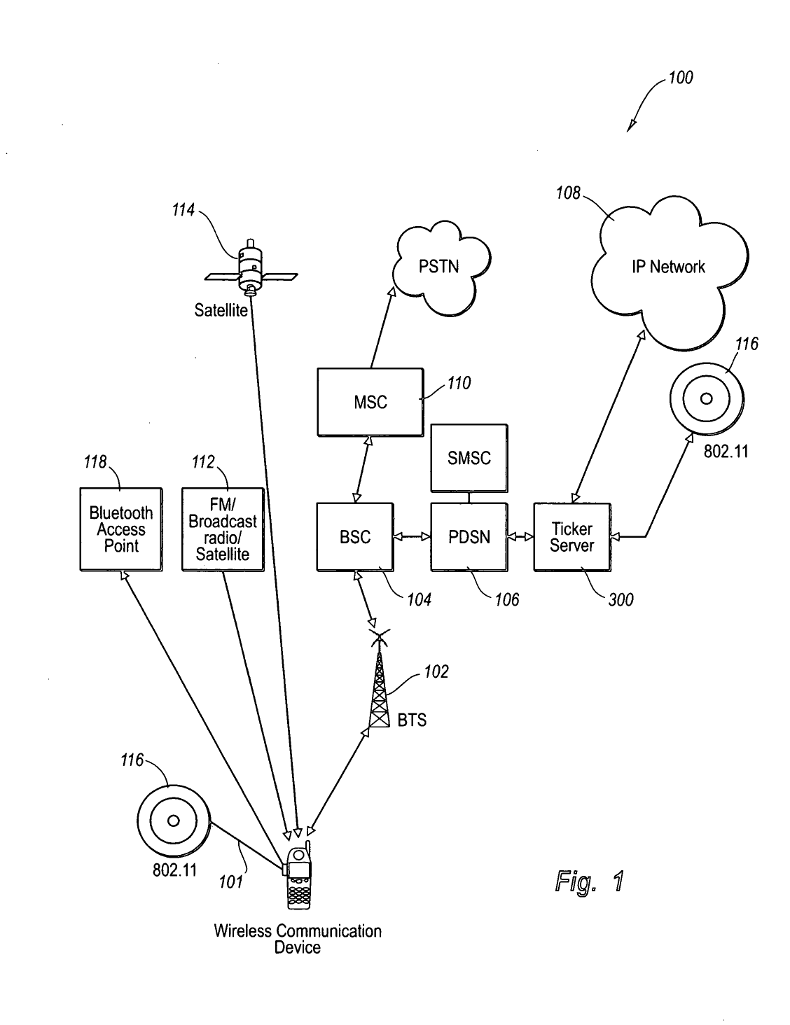

With particular attention now to FIG. 1, one exemplary implementation of an operating environment, denoted generally at 100, is indicated. Although this exemplary operating environment comprises multiple types of networks, including a cellular telephone network, 802.11 networks, Bluetooth access points, and broadcast networks such as FM radio or satellite radio, the invention may be employed in connection with any other type of network and associated landline or wireless communication devices that are effective in implementing or facilitating communication. While FIG. 1 depicts a cellular telephone and exemplary embodiments are directed to the use of cellular telephones in conjunction with the invention, the invention should not be construed to be limited to such devices. As previously noted, many types of communication devices are available and are suitable for use in conjunction with the invention, including set top boxes, cellular telephones, PDAs, smart phones, and many other devices suitably equipped to establish communication with a network and having a display device such as a display screen may be used to implement the methods of the invention. Accordingly, the scope of the invention should not be construed to be limited to the exemplary operating environment indicated in FIG. 1.

In the exemplary illustrated embodiment, the operating environment 100 includes one or more mobile communication devices 101 (also referred to herein as “mobile device(s)” and “the device”) configured to communicate with one or more networks and/or network elements, including base transceiver station (BTS) 102 of the cellular network, internet protocol (IP) network 108, FM or satellite radio broadcast network 112, 802.11 wireless access points 116, and Bluetooth access point 118. One or more of these network elements or bearers may be used to transmit content to the interactive ticker depending on the configuration of the mobile device. Mobile communication device 101 is further configured with ticker client software that enables it, among other things, to communicate with ticker server 300 that may be embodied, in one implementation, as a server operating in conjunction with IP network 108. Ticker server 300 may further interface with other network elements, such as a Short Message Service Center (SMSC) and various gateways to implement the methods of the invention.

II. Receiving and Displaying Content in the Interactive Ticker

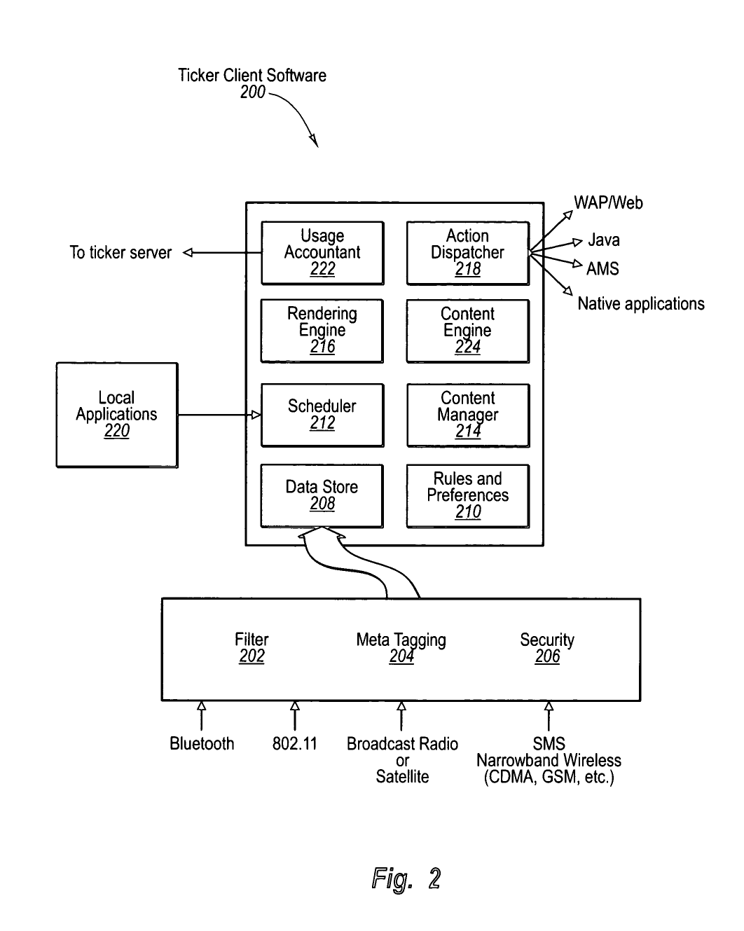

Directing attention now to FIG. 2, details are provided concerning an example of ticker client software 200. Ticker client software 200 resides on the mobile communication devices used in conjunction with the invention. In the exemplary embodiment, ticker client software 200 is installed on mobile communication device 101, which is suitably equipped to establish a connection with one or more networks and send and receive data. Ticker client software 200 may operate in conjunction with a ticker server discussed in more detail below.

Ticker client software may include filter 202, meta tagging mechanism 204 and security system 206. Content can become available to ticker client software 200 operating on mobile communication device 101 from multiple content sources and by using multiple bearers and content delivery mechanisms. In one case, content providers may supply content through various gateways to ticker server 300 or content providers may alternatively submit product and service content to the ticker server directly. In either case, the content may then be transmitted to ticker client software 200 using, for example, a data connection over a cellular network, or via a Short Message Service (SMS) message. Alternatively, location-based content can be supplied to ticker client software 200 directly, without having first been aggregated at ticker server 300. For example, a user of mobile communication device 101 enabled with ticker client software 200 and equipped with a Bluetooth chipset may receive content directly when it encounters another Bluetooth device. Bluetooth is a wireless technology typically used for short range communication of data and voice from one device to another, usually within a small area. One example of such an application would be the ability to receive into the ticker a detailed description of an art exhibit being viewed by the user. In this case, the content sent to mobile communication device 101 is both location-based and context-aware, in that the device automatically senses the Bluetooth connection and receives content specific to the context, in this case an art exhibit.

In addition to communicating the ticker content directly to the device using one of the aforementioned bearers, content can be delivered using any of a number of content delivery mechanisms. For example, when mobile communication device 101 communicates with the Bluetooth access point, it might provide its email address to the art exhibit system. The system could then send specific content to that email address with special codes indicating that it is to be interpreted by the ticker software on that device. Mobile communication device 101 may further be configured to interact with an 802.11 WLAN, and when it encounters a wireless access point of the WLAN it can similarly receive content such as a promotional coupon for a nearby restaurant, and then display it in the interactive ticker at 12 p.m. or at another user-specified lunchtime. Ticker client software 200 may also monitor broadcast networks such as FM radio and satellite radio and “pick and choose” content that is relevant to the user.

Generally, the value of using multiple bearers is that some bearers are better suited to delivering certain types of content than others. In some cases, the ticker system may select a content delivery mechanism based on the nature of the content itself. For example, a very small data payload that should be delivered in “real-time” or near real-time, such as a local traffic alert, may be delivered using broadcast SMS. Conversely, a data payload that is larger in size and that contains personalized content, such as tourist site information that includes a review of a nearby restaurant and a discount coupon, may be delivered over an IP connection. In other situations, the fastest way to obtain real-time data, such as a baseball score, while using the least amount of communication device overhead may be for the ticker client software to obtain the baseball score from a satellite or terrestrial radio broadcast. Furthermore, highly personalized content, regardless of the size of the transmission, may be more appropriately delivered over a cellular network using a data connection. It should be noted that regardless of the content source or bearer, the content is typically transmitted to mobile communication device 101 at a time when the device is not otherwise engaged in a communication session to avoid any disruption in communication.

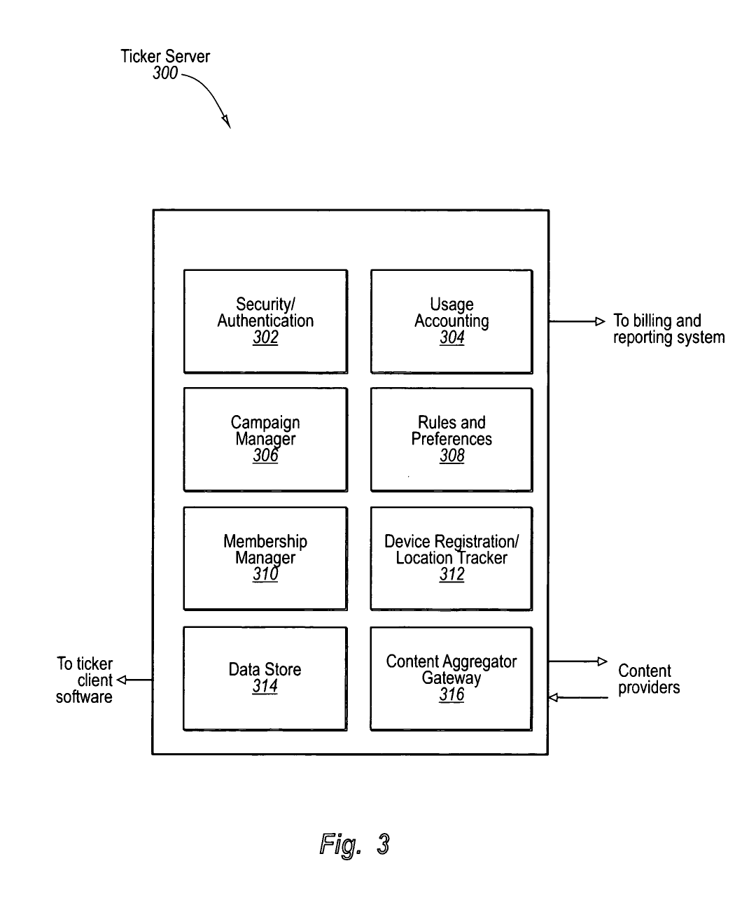

In any case, when content becomes available from a source that is external to ticker client software 200, filter 202 evaluates it to determine if it should be received. Security element 206 further examines the available content to ensure it is from a credible source. If filter 202 decides, based on rules and preferences 210 that the content should be received, and security 206 further endorses receipt of the content, meta tagging module 204 may associate metadata with the content, which describes the attributes of the content being received and which may be in addition to metadata already associated with the content by the content provider. The content is then received into data store 208 and indexed in data store 208 according to its attributes. The aforementioned rules and preferences 210 are specified by the user upon registration and/or subscription with the location-based ticker service to assist in controlling and managing receipt and display of location-based content within the ticker. Among other things, the user can express preferences for certain types of content or the user may block receipt of certain types of content or content sources. The user can further specify preferences for the form taken by the ticker, such as its shape, size, and location on the display of mobile communication device 101. Rules and preferences module 210 provides user interface elements on the mobile communication device that allow the user to configure a variety of content presentation attributes and to modify them at any time. In one example of a user interface element, a “sliding” control mechanism representing a continuum of ticker transparency may be presented to the user. The user may then use a ticker navigation mechanism, such as right and left arrow keys 406 (see FIG. 3) to slide the indicator bar of the sliding control mechanism to the right and to the left across the continuum to designate a degree of transparency that should be applied to the ticker, so that the display behind the ticker can be viewed. This and any other presentation attribute such as colors and fonts can be modified by the user at any time using the various user interface elements of rules and preferences module 210 and one or more ticker navigation mechanisms.

Once received into data store 208, scheduler 212 determines the time at which the data will be displayed relative to all of the data received and scheduled for display within the interactive ticker. In some cases, content may be displayed immediately after its receipt into data store 208, and in other cases, content is received and stored in data store 208 for a period of time before it is displayed within the interactive ticker. Content engine 224 of ticker client software 200 is responsible, among other things, for periodically checking the location of the device and then interfacing with data store 208 to search for matches between the current location of the device and available content. In still other cases, the immediacy of an encounter between a WLAN and the wireless communication device causes content to be received and displayed within the ticker. In all of these cases, scheduler 212 is responsible for determining the timing and order in which all of the available content is displayed in the ticker of mobile communication device 101.

In addition to content received from sources external to the mobile communication device 101, local applications 220 operating on the device 101 can also generate data and submit it to scheduler 212 to be scheduled for display within the interactive ticker. For example, a calendar application may send an appointment alert to scheduler 212 for display within the interactive ticker. The scheduler is able to take into account the time sensitivity of the data and schedule its display within the ticker accordingly.

With continuing attention to FIG. 2, content manager 214 interfaces with data store 208 to manage the ticker content. For example, the content manager keeps only the latest score in a sports game and deletes previous versions. It also deletes old or expired content or content that the user has viewed and should be deleted based on rules contained in the metadata. In one example, a news alert about a particular event may be stored and scheduled for display in the interactive ticker at a particular time. If updated content is subsequently received in data store 208, content manager 214 ensures that the most recent news alert is displayed in place of the older content already scheduled for display.

Rendering engine 216 of ticker client software 200 receives input from rules and preferences module 210 concerning the look and feel of the content displayed in the ticker on mobile communication device 101. For example, the user may want the content to appear in the “traditional” ticker format, wherein it scrolls horizontally across the bottom of the display screen. Alternatively, for example, the user may wish to view the content as a rotating, three-dimensional box, with each face of the box showing a different category of content. The user may further specify that certain categories of content be displayed passively within a scrolling, horizontal ticker, whereas other categories of content should be displayed in a more dramatic way, such as with specialized font attributes, in a particular color, and with accompanying animations, such as “entrance” animations. In any case, ticker navigation mechanisms are used to access and utilize user interface elements that control the behavior of these and other ticker and ticker item attributes.

Presentation effects including contrasting font color, “new” graphics, a change in the order of presented items and audible and tactile alerts may be used to denote new content received. A “free form” ticker could be employed in which new content “flies” onto the display screen without being contained within the specified ticker format(s). Similarly, content can “fade in” or “fade out” from the display screen, or “builds” may be used in which fragments of content are displayed one after the other, rather than all at the same time, until the complete content is displayed. In one example, rendering engine 216 could be instructed to display a particular local traffic update with an entrance animation that flies across the display screen and flashes. The entrance animation could be further accompanied by an audible or tactile notification, such as a ring tone or device vibration to alert the user of a traffic accident on the user's transportation route. Rendering engine 216 may further implement numerous attributes and effects pertaining to the shape, size, location, scroll speed, font attributes, color schemes and themes of the location-based content displayed in the interactive ticker and of the behavior of individual location-based ticker items or categories of location-based ticker items and render them on the display of mobile communication device 101 accordingly.

III. Ticker Use and Interaction

With continuing reference to FIG. 2, as has been previously noted the ticker of ticker client software 200 is interactive. Action dispatcher 218 enables and controls the various ticker navigation mechanisms that may be employed by the device user to interact with user interface elements of the ticker client software and to interact with ticker items. In this manner, action dispatcher 218 manages user interaction with the ticker and interfaces with the rest of the communication device on which the ticker is hosted in response to user input on the mobile device. Moreover, user interaction with a ticker item, such as by clicking on the item, scrolling to it, highlighting it or otherwise selecting the item, can cause a secondary action.

In one example, a URI associated with the ticker item is launched when the user selects the item, such as by clicking on the item or otherwise selecting the item, resulting in display of a web page containing additional content about the item. When a URI is selected and additional information, such as a web page, is selected, the additional information can be obtained by sending a request to a remote server through the communication network in which the communication device operates. In another embodiment, the additional, or supplemental, information can often already be stored locally so that the request can be processed locally rather than requiring the request to be sent to a remote server. The supplemental information can be stored locally by sending the supplemental information to the communication device along with the original ticker item with which the user interacts. For example, if the ticker item is an advertisement for a movie, the communication device can receive a web page with supplemental information about that movie along with the initial ticker item. If the user selects the advertisement, the supplemental web page regarding the movie can be retrieved from local memory rather than requiring the communication device to request the supplemental information from a remote server. This approach is particularly useful in mobile networks that are often relatively slow. Moreover, because the supplemental information is already stored locally in this embodiment, the communication device does not need an active connection with the communication network at the time that the user selects the initial ticker item (e.g., the advertisement) and views the supplemental web page.

In another case, as the user approaches his favorite video store, he may receive an advertisement in the ticker announcing the availability of a new movie available for rent. In this example, the advertisement may be sent to the ticker using MMS as the content delivery mechanism. In another example, selection of an advertisement can give the user the option of downloading a java application for example, which displays a movie trailer. The user may then wish to send an email or other message to the store to reserve the movie. The action dispatcher 218 interfaces with the appropriate external systems to manage download of the java application and dispatch of the message to the store. Once the movie trailer is downloaded, it can be viewed on the communication device. Another example of interactive ticker use is to conduct a poll or a survey. Users leaving the premiere of a new movie could be presented with a poll in the ticker. Using one or more ticker navigation mechanisms, selecting certain items in the ticker would indicate the user's response to the questions in a poll. Similarly, users could receive a customer satisfaction poll upon leaving a retail store from which they have purchased a product or service.

Additionally, data displayed in the interactive ticker from local applications, such as the previously mentioned appointment notification, may be navigated and selected just like any other ticker item, and in some cases, selection of the local application ticker item causes a secondary action to occur, such as invoking the local application. For example, a user may see an appointment notification in the interactive ticker and use a ticker navigation mechanism to pause the ticker on the appointment notification. Selecting the appointment notification ticker item results in the local calendar application being launched and the particular appointment being displayed so the user can view the full details of the impending appointment and perhaps receive driving directions to the appointment based on the user's current location.

Finally, ticker client software 200 employs usage accountant 222 to monitor and track the content displayed within the ticker and the various ways in which the user interacts with the ticker items. For example, selecting an advertisement for a new restaurant may result in driving directions being displayed in a WAP browser, and the user may further be presented with an option for automatically dialing the restaurant phone number to make a reservation. The usage accountant 222 monitors and reports on the transaction so the advertiser receives feedback about response to the advertisement. In this case, whether or not the user dials the phone number is a very important piece of information for the advertiser. At the same time, the selection of the ad by the user is accounted for so the advertiser of the restaurant can be charged, as with pay-for-performance advertising business models. In addition to monitoring and reporting on transactions that result in billing activity, user interaction with ticker items is also aggregated in order to better understand user preferences, supply the user with relevant content which is even more finely tuned over time to meet user needs, and to maximize the effectiveness of advertising campaigns. The usage information is periodically reported to usage accounting 304 of ticker server 300. Moreover, the user may view a historical record of ticker items displayed and a history of interaction with the ticker by selecting an icon in the interactive ticker that serves a web page or otherwise provides a report with the historical ticker data to the user.

Turning now to FIG. 3, a schematic diagram of a mobile communication device 101 and example ticker navigation mechanisms is shown. In this example, the interactive ticker 402 is positioned at the top of the display of the mobile communication device. As previously discussed, the location, shape and size of the ticker are all configurable by the user through the user interface elements of rules and preferences module 210 (reference FIG. 2). Returning to the example in FIG. 3, ticker items that populate the interactive ticker scroll from right to left, although the user may change this ticker attribute and other ticker attributes, such as the default speed at which items scroll. The user may also use arrow keys 406 to scroll right or left and to scroll at a faster rate. Holding the arrow key down may cause the ticker to pause on a certain ticker item. Alternatively, navigation wheel 412 or a similar navigation device may be used to scroll through ticker items. In the example in FIG. 3, ticker item #3 has been paused. Using soft key 404, the user may select ticker item #3 which can cause a secondary action to occur, such as displaying additional details about the topic of ticker item #3 to the user, invoking a local application, downloading other supplemental information or downloading software.

When the user no longer wishes to view ticker item #3, a ticker navigation mechanism, such as keypad key 408 may be used to delete the ticker item from the ticker. It should be noted that the functionality of ticker navigation mechanisms depicted in FIG. 3 are examples only, and ticker navigation mechanism functionality can be implemented in many different ways. Furthermore, the association between specific navigation functionality and ticker navigation mechanisms including, but not limited to keys on the keypad of the mobile device, device soft keys, other device buttons and wheels, voice commands, or device motion may be defined in a variety of ways.

IV. Registration, Content Aggregation, Campaign Management, Offline Navigation

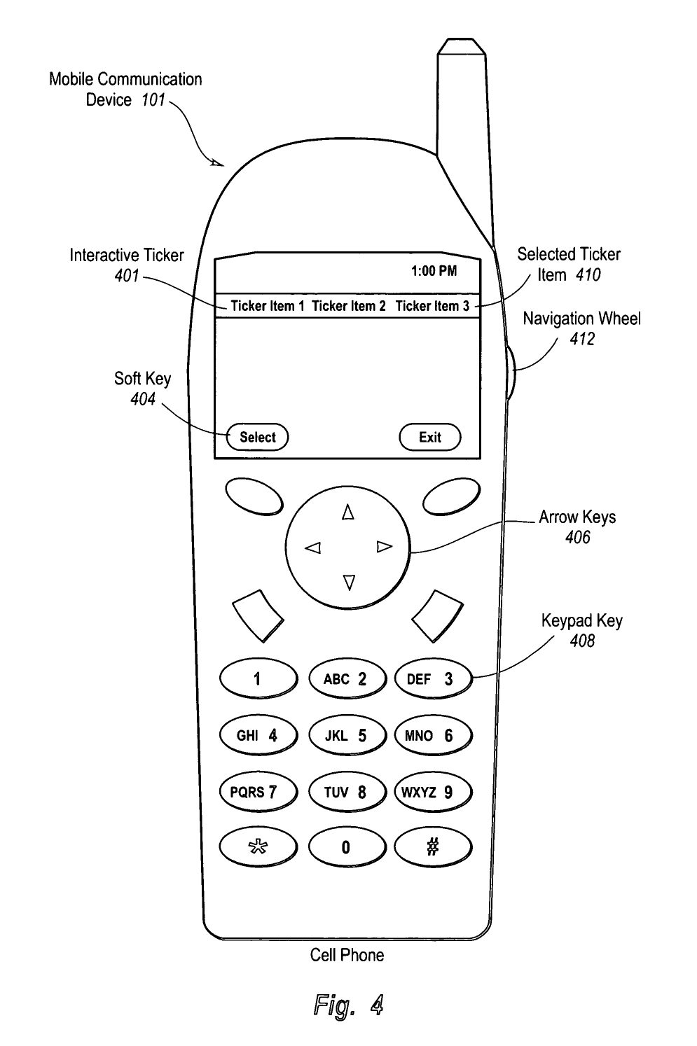

With reference now to FIG. 4, details are provided concerning an exemplary implementation of ticker server 300. In the exemplary embodiment, ticker server 300 operates in conjunction with a plurality of content providers and mobile communication devices 101. To gain access to the content offered by the plurality of content providers, ticker client software 200 resident on mobile communication device 101 registers with device registration and location tracker module 312 of ticker server 300. Using user interface elements of ticker client software 200, the user of mobile communication device 101 may further express rules and preferences concerning the type of content in which s/he is interested and the manner in which it should be displayed within the interactive ticker on the device. Once expressed, the rules and preferences may be stored on mobile communication device 101 in rules and preferences module 210, in rules and preferences module 308 of ticker server 300, or both. Along with specifying rules and preferences, communication devices may also indicate their geographical location to location tracker module 312 in order to receive location-based content. Once the registration process is complete, content may be received from ticker server 300.

In the exemplary embodiment, ticker server 300 aggregates some content, but as previously noted, other content may be delivered via other means to ticker client software 200 on mobile communication device 101. Content providers may become members of the ticker service by registering with the service using membership manager 310. Once registered, content can be provided to the ticker server for distribution to registered mobile communication devices 101. In some cases, content providers can deliver content directly to the ticker client software, and in some situations the user may be prompted to accept or reject the content that is available for provision directly to the ticker client software.

With continuing attention to FIG. 4, content can be delivered to ticker server 300 in various ways. First, content providers, including large entertainment conglomerates such as MTV and Disney, as well as smaller, independent content providers, may feed content to the location-based ticker server through content aggregator gateway 316 that provides a means for potentially disparate content servers to interface with ticker server 300. Content received via content aggregator gateway 316 may then be stored in data store 314. Alternatively, vendors of products and services may choose to input company and product information, as well as advertising and promotions into campaign manager 306 of ticker server 300. In another embodiment, a third party marketing campaign management system may interface with ticker server 300 to deliver content to data store 314. Campaign manager module 306 provides vendors and other content providers the capability to create and manage marketing campaigns for their products and services. Product and service information may be input via a web page and can include details such as the message to appear on the ticker, which customers should see which messages, product descriptions, competitive comparisons, promotional discounts and other information. Terms of use, pricing, promotion duration, and other marketing and advertising campaign details can be specified, implemented and updated using campaign manager 306. In some cases, the content can be encrypted before it is transmitted to the communication device. Decryption can be performed, for example, by transmitting a key from a wireless access point in the network to a mobile communication device at an appropriate time or location to enable the mobile communication device to decrypt content that it already has.

Once the encrypted content is downloaded to data store 208 of ticker client software 200 (reference FIG. 2), when the device arrives at the specified location and at the specified time, campaign manager 306 can initiate transmission of a key to the communication device to “unlock” the content such that it can be displayed within the interactive ticker. Campaign manager 306 further provides capability for receiving feedback from usage accountant 222 of ticker client software 200 (see FIG. 2) and reporting on how many users have responded to vendor campaigns by interacting with a ticker item. In any case, metadata, such as target user demographics and terms and conditions, may be provided along with the content provided to ticker server 300. For example, an automobile manufacturer may specify that its advertisement for a newly released vehicle be sent to communication devices within a certain proximity to a dealership to encourage the user to stop by to view the new vehicle. It may further specify the age of the recipient and also send a special promotional offer to users who are previous buyers from the manufacturer and whose lease agreements are close to expiring

Security and authentication module 302 provides a variety of security services, including secure registration and authentication both for communication device users and for content providers, as well as monitoring the source of incoming content to ensure that only credible, registered users are interacting with the location-based ticker server and that only authenticated content is delivered to the ticker client.

Usage accounting module 304 performs a variety of processes related to tracking the use of the content provided to ticker client software 200, including receiving usage data from usage accountant 222 (depicted in FIG. 2) of ticker client software 200 and exporting usage data to external billing, reporting, and campaign management systems.

As mentioned previously, the device user may use any of the ticker navigation mechanisms to interact with user interface elements of the ticker client software or to interact with ticker items, either while connected to a network or while offline. For example, if the user is navigating through ticker items while offline, the user may interact with ticker items as usual by selecting an item using a ticker navigation mechanism. In some cases, if performance of a secondary action is indicated by selection of the ticker item, the secondary action may be executed locally on the mobile communication device without requiring a network connection. In other cases, performance of the secondary action may require a network connection. a particular interaction dictates that a secondary action be performed by a remote device on the network, such as transmitting a command to a network element that results in supplemental information being downloaded, for example, the action dispatcher 218 of ticker client software 200 stores the command that is indicative of the secondary action and that needs to be transmitted to the network. When a network connection is resumed action dispatcher 218 transmits the command using any of a number of data transmission methods known in the art. In some cases, the command may be transmitted to ticker server 300 and executed by one or more elements or modules of ticker server 300. In other cases, the command may be directed to another network element, such as a content server, an application server or another remote device.

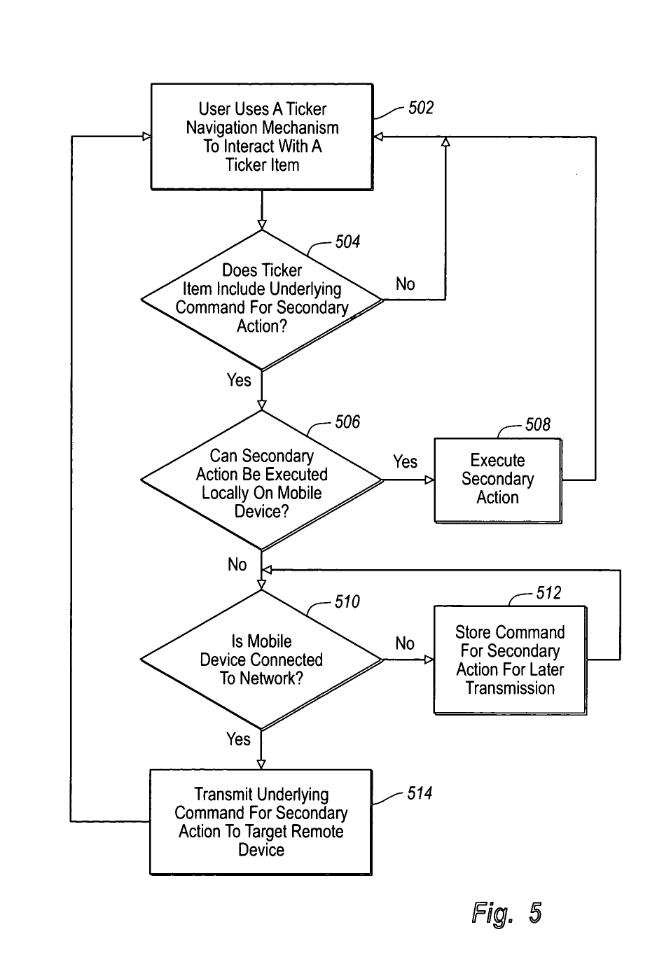

Turning attention now to FIG. 5, a process for navigating ticker items and performing a secondary action is illustrated. In step 502, the user uses one or more ticker navigation mechanisms to interact with a ticker item in the interactive ticker as previously discussed. At step 504 a decision point is reached in which the ticker client software determines if the ticker item includes underlying commands for performance of a secondary action. If there are no such underlying commands for the ticker item, the process returns to step 502. If it is determined that the ticker item includes commands to perform a secondary action, the process proceeds to step 506, in which the ticker client software determines if the underlying command can be executed locally on the mobile device. If so, the command is executed at step 508. If the underlying command must be executed on a remote device, the process continues to step 510 at which another decision point is reached. At this stage, the ticker client software determines if the mobile device has an active connection to a network. If a network connection is not available, the process continues to step 512 in which the command is stored with action dispatcher module 218 of the ticker client software. Once a network connection is resumed, the stored command can be transmitted to the target remote device. If it is determined in step 510 that a network connection is available, the process continues to step 514 in which the command for performing the secondary action is transmitted to the target remote device where it can be executed.

V. Telecommunication Devices and Computing Environments

Embodiments of the present invention may be implemented in connection with a special purpose or general purpose telecommunications device, including wireless telephones and other telephony-enabled wireless devices, landline telephones, or special purpose or general purpose computers that are adapted to have telecommunications or data networking capabilities such as cable set top boxes or PCs. Embodiments within the scope of the present invention also include computer-readable media for carrying or having computer-executable instructions or electronic content structures stored thereon, and these terms are defined to extend to any such media or instructions that are used with telecommunications devices.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, special purpose processing device or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

1. A method of navigating in a ticker displayed on a communication device, comprising:
displaying content on a ticker displayed on a communication device;
receiving user input entered by a user of the communication device into a ticker navigation mechanism of the communication device; and
in response to the user input, modifying the display of the content in the ticker.

2. The method as recited in claim 1, wherein modifying the display comprises selecting an item displayed on the ticker.

3. The method as recited in claim 2, further comprising performing an action is taken in response to selecting an item displayed in the ticker.

4. The method as recited in claim 3, wherein the action comprises displaying multimedia messaging service content.

5. The method as recited in claim 3, wherein the action comprises displaying really simple syndication content.

6. The method as recited in claim 3, wherein the action taken comprises displaying the body of an email.

7. The method as recited in claim 3, wherein the action taken comprises causing an application, services or additional content to be downloaded to the device

8. The method as recited in claim 1, wherein the communication device comprises a set top box.

9. The method as recited in claim 1, wherein modifying the display comprises deleting an item displayed on the ticker.

10. The method as recited in claim 1, wherein modifying the display comprises moving from a current item displayed on the ticker to another, adjacent item.

11. The method as recited in claim 1, wherein the content comprises location-based content that is selected for display on the ticker to correspond to a geographic location of the communication device.

12. The method as recited in claim 1, wherein the ticker navigation mechanism comprises a keypad of the communication device.

13. The method as recited in claim 1, wherein the ticker navigation mechanism comprises soft keys of a display of the communication device.

14. The method as recited in claim 1, wherein the ticker navigation mechanism comprises a voice command receiver of the communication device.

15. The method as recited in claim 1, wherein modifying the display comprises scrolling the ticker.

16. The method as recited in claim 1, wherein modifying the display comprises pausing the ticker.

17. The method as recited in claim 1, wherein modifying the display comprises launching an application resident on the communication device.

18. The method as recited in claim 1, further comprising receiving the content from a ticker server in a network associated with the communication device.

19. The method as recited in claim 18, wherein the content is received using one of a plurality of available bearers.

20. The method as recited in claim 19, wherein said one of the plurality of available bearers is selected based on at least one of:
capabilities of the communication device;
traffic load of the network; and
size, type or priority of the content.

21. A method of performing a secondary action in a ticker displayed on a communication device, comprising:
displaying content on a ticker of a communication device;
receiving user input entered by a user of the communication device through a navigation mechanism of the communication device; and
performing a secondary action that is specified by the user input and is associated with the content displayed on the ticker.

22. The method as recited in claim 21, further comprising navigating between items displayed on the ticker in response to user input entered through the navigation mechanism.

23. The method as recited in claim 21, wherein performing the secondary action comprises:
determining that the user input specifies a particular item of the ticker and requests a secondary action;
determining that the particular item of the ticker has an underlying command associated with the requested secondary action; and
executing the secondary action.

24. The method as recited in claim 23, wherein the secondary action is executed locally on the communication device.

25. The method as recited in claim 23, wherein performing the secondary action further comprises transmitting the underlying command to a target remote device.

26. The method as recited in claim 25, wherein transmitting the underlying command to a target remote device comprises:
determining whether the communication device is connected to a network;
if the communication device is connected to a network, transmitting the underlying command to the target remote device in the network; and
if the communication device is not connected to a network, storing the underlying command for later transmission.

27. The method as recited in claim 21, wherein the communication device comprises a mobile communication device.

28. The method as recited in claim 21, wherein the communication device comprises a set top box.

29. A method of configuring presentation attributes of a ticker of a communication device, comprising:
receiving user input entered by a user of the communication device into a ticker navigation mechanism of the communication device;
in response to the user input, configuring one or more presentation attributes of a ticker of the communication device, wherein the one or more presentation attributes define a manner in which content is to be displayed on the ticker; and
displaying content on the ticker according to the one or more presentation attributes.

30. The method as recited in claim 29, wherein the one or more presentation attributes comprise a transparency value that specifies a transparency of the ticker.

31. The method as recited in claim 30, wherein the transparency value is configured in response to the user input that permits a user to select a desired transparency value using a sliding graphical user interface element.

32. The method as recited in claim 29, wherein the one or more presentation attributes comprise one or more fonts to be used to display text on the ticker.

33. The method as recited in claim 29, wherein the one or more presentation attributes comprise one or more colors to be used to display content on the ticker.

34. The method as recited in claim 29, wherein the communication device comprises a mobile communication device.

35. The method as recited in claim 29, wherein the communication device comprises a set top box.

36. A method of navigating in a ticker displayed on a mobile communication device, comprising:
displaying content on a ticker displayed on a mobile communication device;
receiving user input entered by a user of the mobile communication device into a ticker navigation mechanism of the mobile communication device; and
in response to the user input, modifying the display of the content in the ticker.

37. The method as recited in claim 36, wherein modifying the display comprises selecting an item displayed on the ticker.

38. The method as recited in claim 37, further comprising performing an action in response to selecting an item displayed in the ticker.

39. The method as recited in claim 38, wherein the action comprises displaying multimedia messaging service content.

40. The method as recited in claim 38, wherein the action comprises displaying really simple syndication content.

41. The method as recited in claim 38, wherein the action comprises displaying the body of an email.

42. The method as recited in claim 36, wherein modifying the display comprises launching a uniform resource identifier associated with an item displayed on the ticker.

43. The method as recited in claim 38, wherein the action taken comprises causing an application, services or additional content to be downloaded to the device

44. The method as recited in claim 36, wherein the action taken comprises accessing and displaying supplemental information that has already been transmitted to the communication device prior to the user input.

45. The method as recited in claim 36, wherein modifying the display comprises deleting an item displayed on the ticker.

46. The method as recited in claim 36, wherein modifying the display comprises moving from a current item displayed on the ticker to another, adjacent item.

47. The method as recited in claim 36, wherein the content comprises location-based content that is selected for display on the ticker to correspond to a geographic location of the communication device.

48. The method as recited in claim 36, wherein the ticker navigation mechanism comprises a keypad of the communication device.

49. The method as recited in claim 36, wherein the ticker navigation mechanism comprises soft keys of a display of the communication device.

50. The method as recited in claim 36, wherein the ticker navigation mechanism comprises a voice command receiver of the communication device.

51. The method as recited in claim 36, wherein the ticker navigation mechanism comprises a motion sensor of the communication device.

52. The method as recited in claim 36, wherein modifying the display comprises scrolling the ticker.

53. The method as recited in claim 36, wherein modifying the display comprises pausing the ticker.

54. The method as recited in claim 36, wherein modifying the display comprises launching an application resident on the communication device.
